(19) United States
(12) Patent Application Publication
(10) Pub. No.: US 2006/0051248 A1
(43) Pub. Date: Mar. 9, 2006

(54) Microfluidic bio sample processing apparatus capable of being assembled

(76) Inventors: Hye-jung Cho, Anyang-si (KR); Jeong-gun Lee, Seoul (KR); Sang-Kyun Kang, Seongnam-si (KR); Sang-chae Kim, Suwon-si (KR); Tae-gyun Kim, Suwon-si (KR); Jae-yong Lee, Seongnam-si (KR)

Correspondence Address: CANTOR COLBURN, LLP, 55 GRIFFIN ROAD SOUTH, BLOOMFIELD, CT, 06002, US

(21) Appl. No.: 11/221,176

(22) Filed: Sep. 7, 2005

(30) Foreign Application Priority Data
Sep. 7, 2004 (KR) 2004-71135

(51) Int. Cl. B01L 3/00

(52) U.S. Cl. 422/100; 422/68.1

(57) ABSTRACT

Disclosed is a microfluidic bio sample processing apparatus including a processing module configured for processing the bio sample and having a hole through which the processed bio sample, a solution for processing the bio sample or both flow, a board having a flowing channel connected with the hole so as to allow the bio sample, the solution for processing the bio sample or both to flow between processing modules and a bonding feature for bonding the processing module with the board. The processing modules are configured to be assembled and/or disassembled onto or from the board so that the processing apparatus is adapted to various kinds of bio samples having different processing steps.

This application claims priority to Korean Patent Application No. 2004-71135, filed on Sep. 7, 2004, and all the benefits accruing therefrom under 35 U.S.C. § 119, the contents of which are incorporated herein by reference in their entirety.

### BACKGROUND OF THE INVENTION

1. Field of the Invention

The present invention relates to a microfluidic bio sample processing apparatus capable of being assembled, and more particularly, to a microfluidic bio sample processing apparatus in which the respective processing modules can be replaced with another for assembly during the processing of a bio sample.

2. Description of the Related Art

A bio chip means a biological micro chip that hundreds to hundreds of thousands of biomolecules, such as sequence analyzed DNA, DNA segments, RNA and the like, are arranged at a certain interval and attached on a small solid board. The solid board may be made of glass, silicon, nylon or the like, such that the expression methods, _ the distribution aspects, the mutation and the like, of genes can be analyzed. In a narrow sense, a bio chip technology means a DNA microarray technology that is recognized as high-tech for gene analysis. In a wide sense, bio chip technology means a technology, such as a biosensor, made by the combination of biological material and existing physic, chemistry and a photoconverter, a DNA probe involved DNA microarray, a protein chip using protein such as an enzyme or antigen and antibody, a cell chip using plant cell, a neuron chip directly using nerve cell and the like.

A concept of lab on a chip (LOC) has been introduced into such bio chip technology, so as to integrate all the laboratory functions, such as a pretreatment, a derivatization, a separation, an analysis and the like, of the sample into a single chip. A practical biological sample, such as blood, urine, cell, saliva, or various kinds of samples, such as natural substances, chemicals, food products and medicines are directly used on the chip to implement such laboratory functions. A DNA-LOC and a protein-LOC are in development. For example, such LOC is one that essentially performs the functions of a valve, a liquid quantity measurement equipment, a reactor, an extractor and a separation system. These functions are required for the sample pretreatment process of an autoanalyzer being used for an analysis of biochemical materials. Here, sensor technology is concentrated on a single chip.

FIGS. 1A to 1C are schematic views showing a conventional bio sample processing apparatus. FIG. 1A is a conceptional view of an LOC of the bio sample processing apparatus and FIG. 1B is a view showing a box-type bio sample processing apparatus coupled with a plurality of the bio sample processing apparatuses of FIG. 1A. FIG. 1C is a view showing an on-board type bio sample processing apparatus using the chip of FIG. 1A.

Referring to FIGS. 1A and 1B, the box-type bio sample processing apparatus has an external pump, a chamber, a valve, and a reacting place. A series of bio processing steps are conducted by use of an external pneumatic pump as a driving source for movement of a sample. Samples introduced into the bio sample processing apparatus are processed with a lysis, an extraction, a purification and a mixing, and process modules for implementing the respective processes are supplied with buffer and reagent, or discharge waste.

Referring to FIG. 1C, the on-board type bio sample processing apparatus conducts a lysis, an extraction, a purification, a mixing, an amplification and a detection with a micro electromechanical system (MEMS) pump as a driving source for movement of a sample. Comparing with the box-type processing apparatus, the on-board type processing apparatus conducts a series of processes of bio sample on a single planar chip.

In every bio sample, processing steps required for the respective sample are different from another bio sample. These processing steps may include, a lysis, an extraction, a purification, a mixing, an amplification and a detection as described above. Since a particular unit may process the processing steps in a different combination or order from another unit, a bio sample processing apparatus cannot process various kinds of samples. Also, since the respective process modules of the bio sample processing apparatus cannot be replaced, the whole bio sample processing apparatus cannot be used even when a problem occurs in a single process module.

### SUMMARY OF THE INVENTION

The present invention provides a microfluidic bio sample processing apparatus capable of being assembled by combining respective process modules for processing steps required of a bio sample. Advantageously, a single bio sample processing apparatus can process various kinds of samples.

In an exemplary embodiment of a The bio sample processing apparatus, the apparatus includes a processing module having a hole through which the processed bio sample and a solution for processing the bio sample flow, a board having a flowing channel connected with the hole so as to flow the bio sample, the solution for processing the bio sample or both between processing modules and a bonding feature for bonding the processing module with the board.

In another exemplary embodiment, the processing module includes a processing section configured for processing the bio sample, and a cover section configured for covering the processing section and having the hole through which the processed bio sample and the solution for processing the bio sample flow between the flowing channel and the processing module. The bonding feature is formed at the cover section.

In another exemplary embodiment, the processing module is configured for conducting a separation, a lysis, an extraction, a purification, a mixing, an amplification and a detection or any combination including at least one of the foregoing.

In another exemplary embodiment, the cover section includes at least two holes. The bio sample and/or the solution for processing the bio sample is introduced into the processing module through one hole and discharged from the processing module through the other hole.

In another exemplary embodiment, the apparatus further comprises a valve configured for regulating a fluidic amount of the bio sample, the solution for processing the bio sample or both flowing into the flowing channel, the valve being opened and closed according to the fluidic amount.

In another exemplary embodiment, the apparatus further includes an aligning protrusion configured for preventing a leakage of the bio sample, the solution for processing the bio sample or both flowing into the flowing channel after coupling the processing module with the board.

In another exemplary embodiment, the apparatus further includes an electrical connector configured for driving the bio sample, the solution for processing the bio sample or both, wherein the electrical connector is disposed within the processing module and on the board.

In another exemplary embodiment, the bonding feature includes an adhesive bond, a mechanical bond, a double-sided tape and a solder or any combination including at least one of the foregoing.

In another exemplary embodiment, and the processing module includes silicon, polymer, glass or any combination including at least one of the foregoing.

In another exemplary embodiment, the flowing channel is formed outside the processing module, the flowing channel being connected with a storage unit configured for storing a solution for processing the bio sample, a waste solution used in the processing module or both

In another exemplary embodiment, a storage unit is formed inside the processing module.

### BRIEF DESCRIPTION OF THE DRAWINGS

The above aspects and features of the present invention will be more apparent by describing certain embodiments of the present invention with reference to the accompanying drawings, in which:

FIGS. 1A to 1C are schematic views of a conventional bio sample processing apparatus;

FIGS. 2A to 2C are schematic views of a microfluidic bio sample processing apparatus capable of being assembled according to the present invention;

FIG. 3A is a cross section view of an exemplary embodiment of a processing module of a microfluidic bio sample processing apparatus according to the present invention;

FIGS. 3B and 3C are a cross section view and a plan view, respectively, of exemplary embodiments of a microfluidic bio sample processing apparatus according to the present invention; and

FIGS. 4A and 4B are schematic views of an exemplary embodiment of a fluidic channel of a microfluidic bio sample processing apparatus having a valve according to the present invention.

### DETAILED DESCRIPTION OF THE INVENTION

Hereinafter, the present invention will be described in detail with reference to the drawings.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

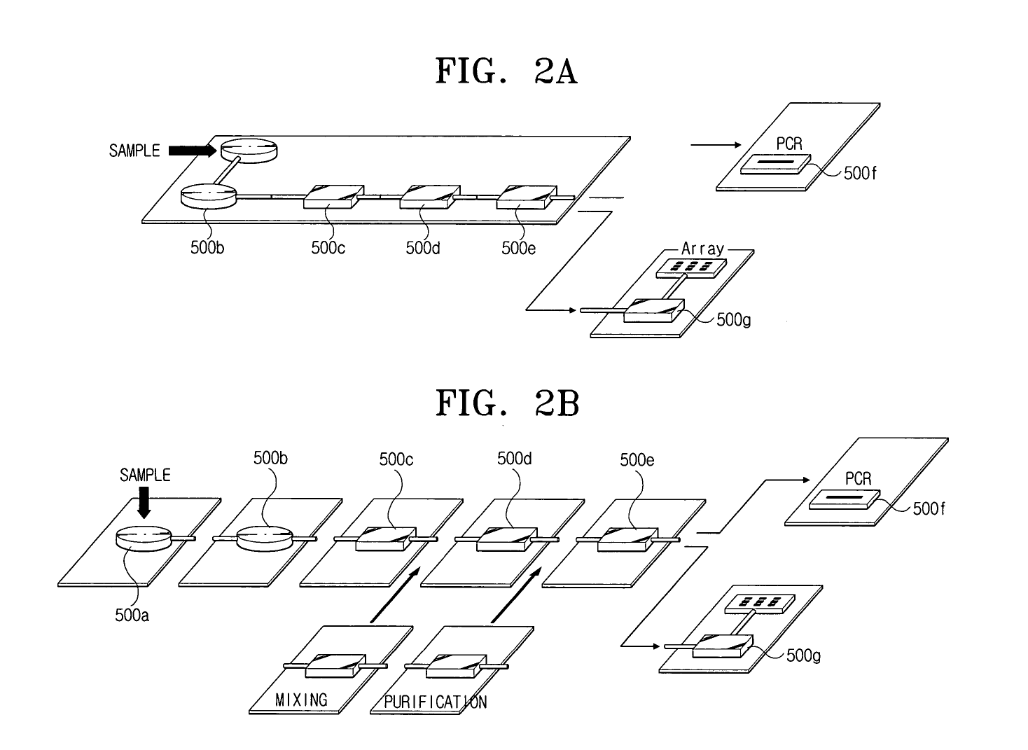

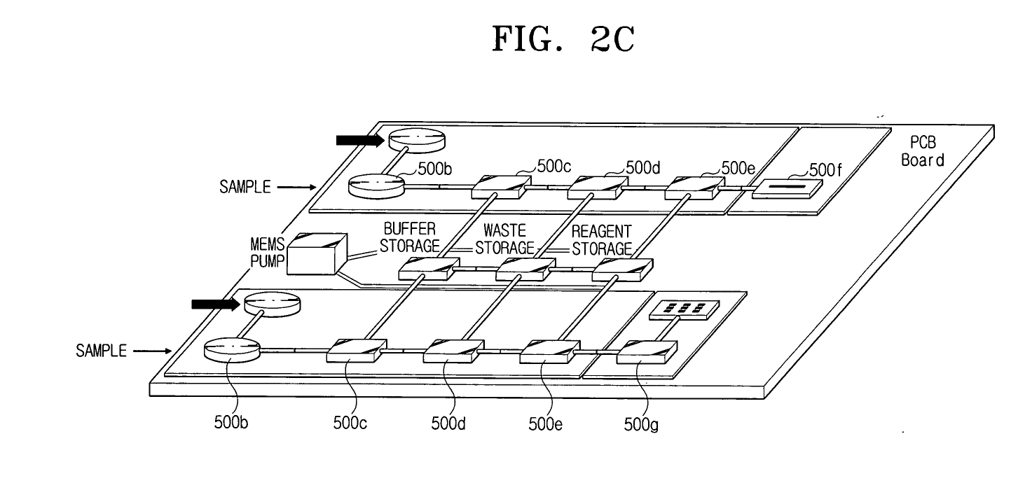

FIGS. 2A to 2C are schematic views of exemplary embodiments of a microfluidic bio sample processing apparatus capable of being assembled according to the present invention. FIGS. 2A and 2B are views of the microfluidic bio sample processing apparatus with the processing modules unassembled, and FIG. 2C is a view of the same with the processing modules assembled.

Referring to FIGS. 2A and 2B, in the steps of processing the bio sample, the respective processing modules of the bio sample include a lysis processing module 500b, an extraction processing module 500c, a purification processing module 500d, and a mixing processing module 500e. In exemplary embodiments, the processing modules 500a-500e may be assembled in any order as required by the sample and may be replaced with another processing module.

In the exemplary embodiment of FIG. 2A, the lysis processing module 500b, the extraction processing module 500c, the purification processing module 500d, and the mixing processing module 500e are shown to be fixed on a single base. If necessary, in other exemplary embodiments, an amplification and detection processing module 500f or a processing module 500g for amplification, detection and array may be coupled to the mixing processing module 500e. The set of processing modules may detect whether or not the bio coupling is provided as well as pre-processing of the bio sample.

In FIG. 2A, although the lysis processing module 500b, the extraction processing module 500c, the purification processing module 500d, and the mixing processing module 500e are shown to be fixed, in alternative embodiments, users may change the design if necessary, such that only particular processing modules, for example, the lysis processing module 500b and the extraction processing module 500c, are fixed and the other modules are capable of being replaced.

For example, FIG. 2B shows the processing modules 500a-500e disposed on separate bases, or boards, so that the processing modules 500a-500e may be assembled or disassembled if necessary. A separation processing module 500a, the lysis processing module 500b, the extraction processing module 500c, the purification processing module 500d, and the mixing processing module 500e are shown separated. In other exemplary embodiments, the amplification and detection processing module 500f or the processing module 500g for amplification, detection and array may be coupled to the mixing processing module 500e.

In alternative embodiments, according to the type of samples, a mixing processing module may be added between the extraction processing module 500c and the purification processing module 500d. Another purification processing module may also be added between the purification processing module 500d and the mixing processing module 500e. For the samples requiring different bio-processing steps, only the necessary processing modules may be assembled so that a bio sample processing apparatus may be obtained appropriate to the bio samples. Advantageously, a separate bio sample processing apparatus for each set of processing steps and each sample is not required

In another exemplary embodiment a buffer storage unit referring to FIG. 2C for storing buffers necessary for the respective processing modules, a waste storage unit referring to FIG. 2C for storing a waste discharged after sample washing, and a reagent storage unit referring to FIG. 2C for storing reagent for detecting the bio coupling of the bio sample may be connected with the respective processing modules. In alternative embodiments, the buffer storage unit, the waste storage unit, and the reagent storage unit may be formed within the respective processing modules.

FIG. 2C shows an exemplary embodiment of a bio sample processing apparatus after the processing modules are assembled, in which the lysis processing module 500b, the extraction processing module 500c, the purification processing module 500d, and the mixing processing module 500e are thereto fixed. The amplification and detection processing module 500f and the processing module 500g for amplification, detection and array are connected to the fixed processing modules.

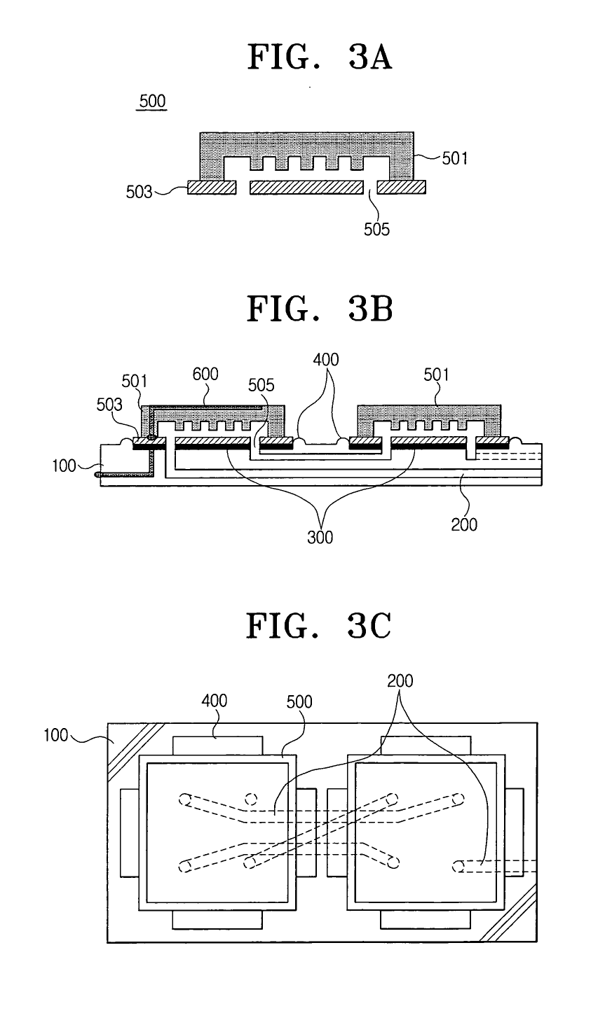

FIG. 3A is an end view of an exemplary embodiment of a processing module 500 of a microfluidic bio sample processing apparatus according to the present invention.

Referring to FIG. 3A, the processing module 500 includes a processing section 501 and a cover section 503 having a hole 505. The hole 505 is a passage through which the fluidic bio sample moves from the processing module 500 to another processing module or vice versa. In another exemplary embodiment, the hole 505 may be a passage through which reagent stored in the reagent storage unit referring to FIG. 2C may be introduced into the processing module 500 or the waste solution used in the processing module 500 is discharged. In alternative embodiments, the cover section 503 of the processing module 500 may have two holes, one through which fluidic substances may be introduced into the processing module 500 and the other through which fluidic substances may be discharged from the processing module 500.

The processing section 501 may include silicon, polymer, glass, or the like, as well as any combination including at least one of the foregoing. The processing section 501 is coupled with the cover section 503 by any appropriate means.

FIGS. 3B and 3C are an end view and a plan view, respectively, of an exemplary embodiment of a microfluidic bio sample processing apparatus according to the present invention.

Referring to FIGS. 3B and 3C, the microfluidic bio sample processing apparatus includes a board 100, a processing module 500, a flowing channel 200, a bonding feature 300, an aligning protrusion 400 and an electrical connector 600.

As abovementioned with reference to FIG. 3A, the processing module 500 includes a processing section 501 and a cover section 503 having a hole 505. According to required processing steps of the bio sample, such processing module 500 may be a separation processing module 500a, a lysis processing module 500b, an extraction processing module 500c, a purification processing module 500d or a mixing processing module 500e.

The flowing channel 200 may be formed on the board 100 and serves as a passage through which the bio sample moves from one processing module to another module. The flowing channel 200 is connected with the hole 505 of the cover section 503 of the processing module 500. Based on the connection of the flowing channel 200 with the hole 505, the bio sample may be moved from the processing module 500 to the flowing channel 200 or vice versa.

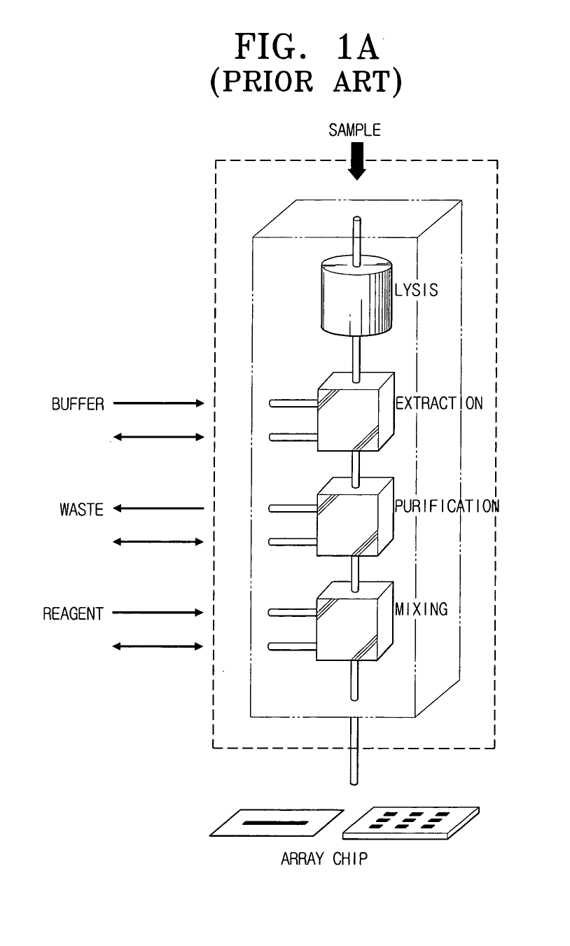

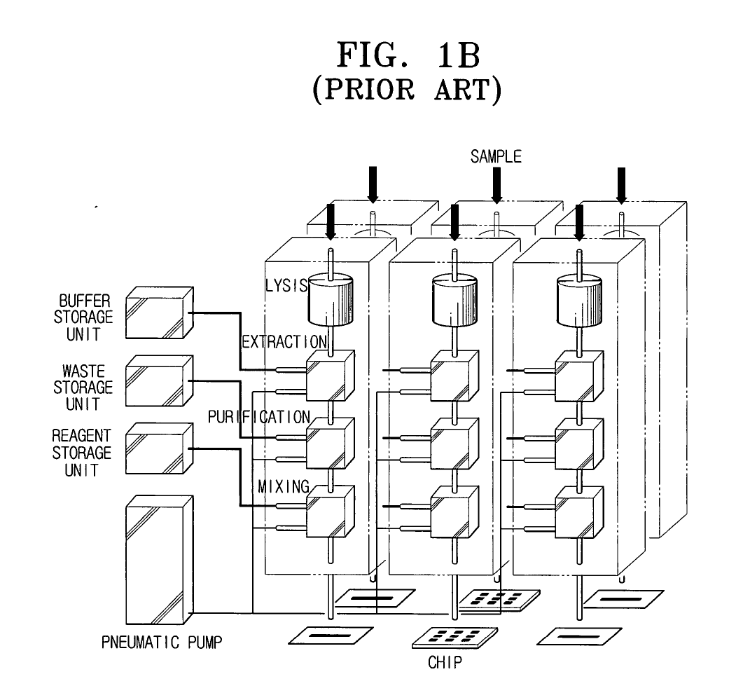

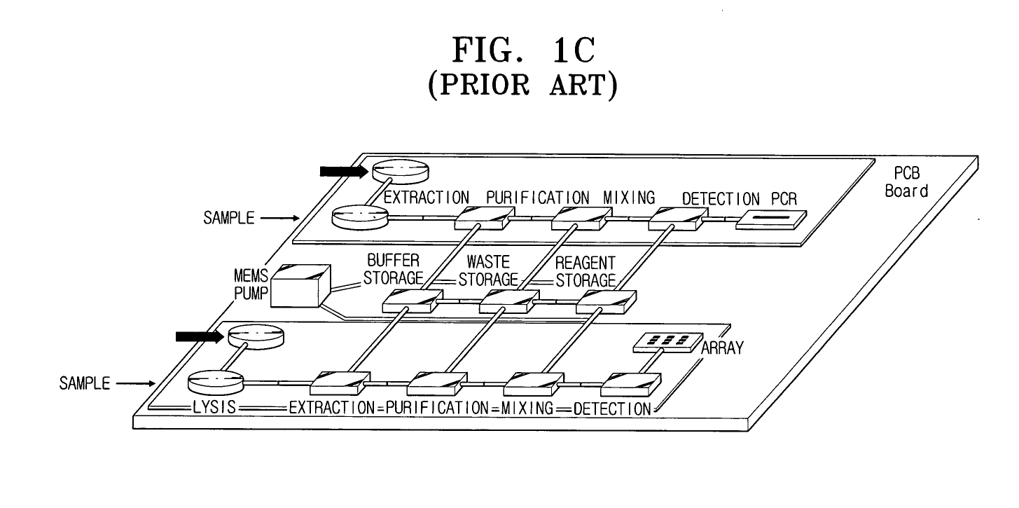

The bonding feature 300 bonds the processing module 500 to the board 100. When the processing modules 500a-500g referring to FIGS. 1A-2C, for example, are required to process a certain bio sample, the processing modules 500a-500g may be bonded to the board 100 by the bonding feature 300. In exemplary embodiments, the bonding feature 300 may be made of a material such that the respective processing modules may be detachably bonded to the board 100 to allow the processing modules formed at a certain position of the board 100 to be replaced with other processing modules. The material of the bonding feature 300 may include, but is not limited to, an adhesive bond, a mechanical bond, a solder, and a double-sided tape.

The aligning protrusion 400 may be employed to further secure the processing modules 500 to the board 100 upon bonding of the processing modules 500 to the board 100. As illustrated in FIG. 3C, the aligning protrusion 400 may be formed at the upper and lower portions of the processing module 500.

The electrical connector 600 may be disposed within the processing module 500 and on the board 100. In alternative embodiments, the electrical connector may be disposed outside the processing module 500. In other exemplary embodiments, the electrical connector 600 may be formed of a conductive material. The electrical connector 600 may serve as a heater for supplying heat to move the bio sample and the solution required for processing of the bio sample. In other exemplary embodiments, the electrical connector 600 may also function as an electrode.

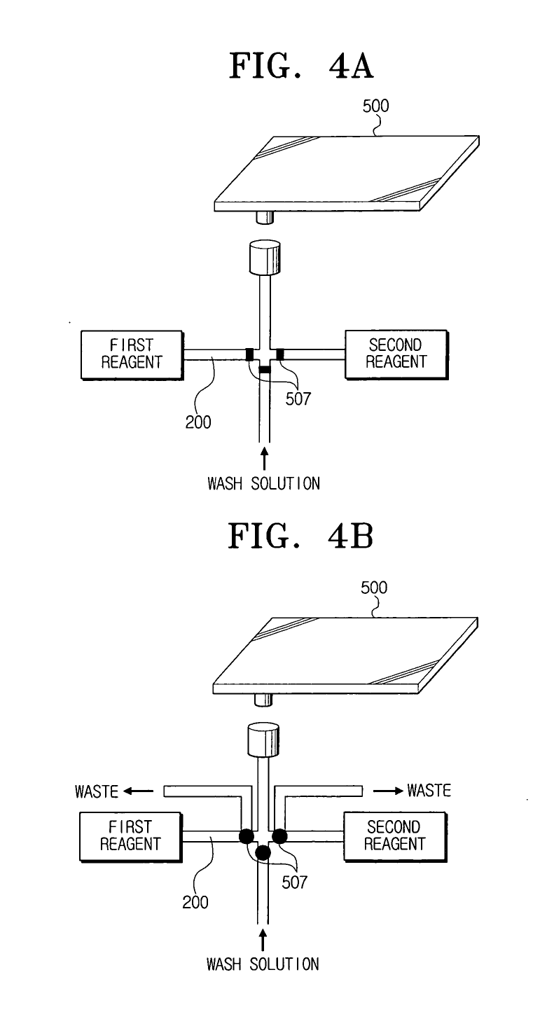

FIGS. 4A and 4B are schematic views of exemplary embodiments of a flowing channel 200 to which a valve 507 is formed in a microfluidic bio sample processing apparatus according to the present invention. FIG. 4A shows the processing module 500 configured for a waste storage unit (not shown) provided inside the processing module 500, and FIG. 4B shows the processing module 500 configured for a waste storage unit (not shown) provided outside the processing module 500.

Referring to FIG. 4A, the valve 507 is formed at the flowing channel 200 formed on the board 100 so as to regulate a fluidic amount of a wash solution injected to the processing module 500. Herein, the opening of the valve 507 is regulated according to the fluidic amount. The wash solution injected into the processing module 500 is firstly used for processing of the bio sample and then is stored in the waste storage unit formed inside the processing module 500. In other exemplary embodiments, according to the types of the processing modules, the injecting solution may be other various reagents in addition to the wash solution.

Referring to FIG. 4B, like FIG. 4A, the valve 507 is formed at the flowing channel 200 formed on the board 100 so as to regulate a fluidic amount of a wash solution injected to the processing module 500. The wash solution injected into the processing module 500 is firstly used for processing of the bio sample and then is stored in the waste storage unit formed outside the processing module 500. In other exemplary embodiments, according to the types of the processing modules 500, the injecting solution may be other reagents or buffer in addition to the wash solution.

As described above, the bio sample processing apparatus of the present invention may be fabricated in a manner the respective processing modules are not fixed on a board, but the respective processing modules are assembled according to a processing function required by the bio samples. In other words, the respective processing modules 500 may be previously fabricated as an independent element. Then, the processing modules 500 required according to the bio samples are coupled onto the board. Advantageously, the bio sample processing apparatus previously fabricated and then assembled may be a lab in a package (LIP).

In exemplary embodiments as described above, the respective independent processing modules may be assembled and/or disassembled on or from the board, respectively. Advantageously, the processing apparatus may be configured to adapt to various kinds of bio samples having different processing step requirements.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A microfluidic bio sample processing apparatus comprising:
a processing module having a hole through which a processed bio sample, a solution for processing a bio sample, or both flow;
a board having a flowing channel, the flowing channel connected with the hole and configured to allow the bio sample, the solution for processing the bio sample or both, to flow between processing modules; and
a bonding feature configured for bonding the processing module with the board.

2. The apparatus as claimed in claim 1, wherein the processing module includes
a processing section configured for processing the bio sample, and
a cover section configured for covering the processing section, the cover section having the hole through which the processed bio sample and the solution for processing the bio sample flow between the flowing channel and the processing module,
wherein the bonding feature is formed at the cover section.

3. The apparatus as claimed in claim 1, wherein the processing module is configured for conducting a separation, a lysis, an extraction, a purification, a mixing, an amplification and a detection, or any combination including at least one of the foregoing.

4. The apparatus as claimed in claim 1, wherein the hole is at least ones through which the bio sample and the solution for processing the bio sample are introduced/discharged into/from the processing module.

5. The apparatus as claimed in claim 1, further comprising a valve configured for regulating a fluidic amount of the bio sample, the solution for processing the bio sample or both flowing into the flowing channel.

6. The apparatus as claimed in claim 5, wherein the valve is configured to open and close according to the fluidic amount.

7. The apparatus as claimed in claim 1, further comprising an aligning protrusion configured for prevent a leakage of the bio sample, the solution for processing the bio sample or both flowing into the flowing channel after coupling the processing module with the board.

8. The apparatus as claimed in claim 1, further comprising an electrical connector configured for driving the bio sample, the solution for processing the bio sample or both, wherein the electrical connector is disposed within the processing module and on the board.

9. The apparatus as claimed in claim 1, wherein the bonding feature includes an adhesive bond, a mechanical bond, a double-sided tape, a solder, or any combination including at least one of the foregoing.

10. The apparatus as claimed in claim 1, wherein the processing module includes silicon, polymer, glass, or any combination including at least one of the foregoing.

11. The apparatus as claimed in claim 1, wherein the flowing channel is formed outside the processing module, the flowing channel being connected with a storage unit configured for storing a solution for processing the bio sample, a waste solution used in the processing module or both.

12. The apparatus as claimed in claim 1, wherein a storage unit is formed inside the processing module.

13. The apparatus as claimed in claim 1, wherein a storage unit is formed outside the processing module.

14. The apparatus as claimed in claim 1, further comprising a storage unit associated with the processing module, the storage unit including a buffer storage unit, a waste storage unit, a reagent storage unit, or any combination including at least one of the foregoing.

15. The apparatus as claimed in claim 1, wherein the bonding feature is configured for detachably bonding the processing module with the board.

16. The apparatus as claimed in claim 1, wherein the bonding feature is configured for fixably bonding the processing module with the board.

17. The apparatus as claimed in claim 1, wherein a plurality of processing modules are bonded on the board.

18. The apparatus as claimed in claim 1, wherein a plurality of boards each having a processing module bonded therewith are assembled.

19. The apparatus as claimed in claim 19, wherein the plurality of boards are assembled onto a single base.
